(19) United States
(12) Patent Application Publication
(10) Pub. No.: US 2025/0390820 A1
(43) Pub. Date: Dec. 25, 2025

(54) Techniques for Advanced Exascale AI Workflow Synthesis

(71) Applicant: REGENTS OF THE UNIVERSITY OF MICHIGAN, Ann Arbor, MI (US)

(72) Inventors: Venkat Raman, Ann Arbor, MI (US); Vansh Sharma, Ann Arbor, MI (US)

(21) Appl. No.: 19/248,224

(22) Filed: Jun. 24, 2025

Related U.S. Application Data
(60) Provisional application No. 63/663,687, filed on Jun. 24, 2024.

(51) Int. Cl. G06Q 10/0631; G06F 9/50

(52) U.S. Cl. CPC G06Q 10/06316; G06F 9/5016; G06F 9/5055

(57) ABSTRACT

Systems and methods for scientific computing using an artificial intelligence (AI) agent are disclosed herein. The system may receive a prompt input including a scientific query; generate, by processing the prompt input using an artificial intelligence (AI) agent including a trained machine learning (ML) model, a set of tasks for answering the scientific query; determine, by the AI agent, one or more tools to execute the set of tasks based on available memory resources; execute the set of tasks using the one or more tools to generate output data corresponding to the scientific query; determine, by the AI agent based on the output data, an observation associated with the scientific query or a ranked listing of the output data; and cause at least one of (i) the output data, (ii) the observation, or (iii) the ranked listing to be displayed on an output computing device.

### CROSS-REFERENCE TO RELATED APPLICATION

This application claims priority to and the benefit of the filing date of provisional U.S. Patent Application No. 63/663,687 entitled “Techniques for Advanced Exascale AI Workflow Synthesis,” filed on Jun. 24, 2024, the entirety of which is hereby expressly incorporated herein by reference.

### TECHNICAL FIELD

The present disclosure generally relates to scientific computing, and more particularly, to systems and methods for generating output data associated with a scientific query.

### BACKGROUND

The use of artificial intelligence (AI) agents for computing has been a topic of study for many different fields. However, challenges exist when using AI agents for scientific computing.

In particular, conventional techniques do not consider available memory resources in a computing system, which may cause system failure if a tool or model used to run the scientific computations uses more memory than is available, for example. While interaction and outcome data may be stored in memory for one-shot or few-shot prompt templates, such data is currently not stored in long-term memory and used to retrain the AI agent. Moreover, conventional techniques for using AI agents scientific computing do not consider computing in an exascale environment. Additionally, while large language models (LLMs) utilized by AI agents are generally able to generate responses for general-purpose use, such general-purpose responses may be inadequate for answering a scientific query. For example, while an LLM may be able to rank output data, the LLM's ranking is based on consumer or other contexts rather than a scientific context, leading to less useful results.

Therefore, in general, the use of AI agents for scientific computing, particularly in exascale computing environments is an area of great interest, and conventional techniques are insufficient for accurate and efficient use of an AI agent for such computing. Accordingly, a need exists for techniques that consider available memory resources in a system, improve the operation of an AI agent, and provide users with more accurate output data, thereby mitigating the negative effects stemming from inaccurate, inefficient conventional techniques.

### SUMMARY

The present embodiments relate to systems and methods for solving computational problems using high-performance computing.

In one embodiment, a system for scientific computing may include one or more processors; and one or more memories having stored thereon computer-executable instructions that, when executed by the one or more processors, cause the system to receive a prompt input including a scientific query; generate, by processing the prompt input using an artificial intelligence (AI) agent including a trained machine learning (ML) model, a set of tasks for answering the scientific query; determine, by the AI agent, one or more tools to execute the set of tasks based on available memory resources; execute the set of tasks using the one or more tools to generate output data corresponding to the scientific query; determine, by the AI agent based on the output data, an observation associated with the scientific query or a ranked listing of the output data; and cause at least one of (i) the output data, (ii) the observation, or (iii) the ranked listing to be displayed on an output computing device.

In another embodiment, a method for scientific computing may include receiving, by one or more processors a prompt input including a scientific query; generating, by the one or more processors and processing the prompt input using an artificial intelligence (AI) agent including a trained machine learning (ML) model, a set of tasks for answering the scientific query; determining, by the one or more processors and the AI agent, one or more tools to execute the set of tasks based on available memory resources; executing, by the one or more processors, the set of tasks using the one or more tools to generate output data corresponding to the scientific query; determining, by the one or more processors and the AI agent based on the output data, an observation associated with the scientific query or a ranked listing of the output data; and causing, by the one or more processors, at least one of (i) the output data, (ii) the observation, or (iii) the ranked listing to be displayed on an output computing device.

### BRIEF DESCRIPTION OF THE DRAWINGS

The figures described below depict preferred embodiments for purposes of illustration only. One skilled in the art will readily recognize from the following discussion that alternative embodiments of the systems and methods illustrated herein may be employed without departing from the principles of the disclosure described herein.

FIG. 1 depicts a block diagram of an example computing environment in which methods and systems for scientific computing, according to some embodiments.

FIG. 2 depicts a flow diagram for example machine learning model training and operation, according to some embodiments.

FIG. 3 depicts an example system for scientific computing, according to some embodiments.

FIG. 4 depicts an example workflow for an example prompt input.

FIG. 5 depicts a flow diagram of an example method for scientific computing, according to one embodiment.

### DETAILED DESCRIPTION

The techniques of the present disclosure relate to using an AI agent for scientific computing. The AI agent processes a prompt input including a scientific query to generate a set of tasks for answering the scientific query. The AI agent determines what tools and/or machine learning models to use to execute the set of tasks based on available memory resources, executes the sets of tasks using the one or more tools to generate output data, and determines observations and/or a ranked listing of output data associated with the scientific query based on the output data. As a result of these elements, the techniques of the present disclosure improve over conventional techniques at least by: (1) generating outputs more efficiently than conventional techniques, (2) improving the operation of an AI agent, and (3) generating more accurate outputs than conventional techniques.

As discussed above, conventional techniques do not consider available memory resources when executing tasks to respond to a prompt input. Thus, using the conventional techniques may result in reduced computing efficiency. For example, loading and utilizing a tool and/or machine learning model that uses more memory resources than are available may cause system failure. In another example, even if there is enough memory to support use of a particular tool and/or model, the use of the particular tool and/or model without consideration of memory resources may lead to slow execution of tasks. Further, should conventional techniques experience changes in available memory resources during task execution, such techniques are unable to adapt to these changes, leading to additional task execution delay.

The techniques of the present disclosure overcome these issues and thereby improve computing efficiency. In particular, the present techniques include loading and utilizing tools and models based on available memory resources, avoiding system failures and slow execution of tasks. By generating a set of tasks and determining which tools to use to execute such tasks based on available memory resources, the present techniques provide a computing resource-efficient end-to-end task resolution process that intelligently and efficiently evaluates input (e.g., scientific) queries to determine an optimal resource dedication for answering each query. Such task generation and execution were previously unachievable using conventional techniques, as conventional techniques did not consider available memory resources when generating and executing tasks for answer queries, such that the present techniques improve over conventional techniques. Thus, the techniques of the present disclosure improve the functioning of a computing device by considering available memory resources in a system before executing relevant tasks to thereby improve computing efficiency and simultaneously reduce system failure rates/instances resulting from the use of tools and/or machine learning models that require more memory resources than are available.

The techniques of the present disclosure therefore improve the functionality of a computing device (e.g., a hosting server) at least by analyzing data in a particular way to enhance the accuracy and efficiency of the computing device. The AI agent, executing on the computing device, generates a set of tasks, determines tools to execute the set of tasks, and executes the set of tasks with an accuracy and efficiency not achieved using conventional techniques. That is, the present disclosure describes improvements in the functioning of the computer itself because the computing device more accurately and efficiently analyzes/utilizes data as a direct result of the AI agent intelligently considering the available memory resources in the system and determining which tools to use based on the available memory resources. This improves over the prior art at least because existing systems do not consider available memory resources, leading to potential system failures and/or slow execution of tasks, and/or are otherwise unable to analyze data with the accuracy and efficiency resulting from the consideration of available memory resources.

Additionally, in certain embodiments, the techniques of the present disclosure improve the operation of an AI agent. As discussed above, conventional techniques do not store AI agent interaction and outcome data in long-term memory, nor is such data used to retrain an AI agent. Furthermore, a conventional AI agent utilizing a conventional LLM may not provide a useful response in a scientific context. In contrast, the present techniques include storing tuples for controlling a decision-making process of the agent, which then may be used to retrain the AI agent for future interactions. The use of such tuples for controlling a decision-making process of the agent may also be used to train the AI agent to provide more relevant responses, particularly in a scientific context. Thus, the present techniques improve the functioning of an AI agent.

Further, in some embodiments, the present techniques provide additional improvements to the functionality of a computing device. The AI agent may store tuples controlling a decision-making process in long-term memory and use the tuples to retrain the AI agent to produce more accurate output data. The functioning of the computer itself is improved by storing tuples controlling a decision-making process and using the tuples to retrain the AI agent because the computing device more accurately analyzes and utilizes data to provide more accurate output data over time by iteratively retraining the AI agent with the stored tuples. This improves over the prior art at least because existing systems do not store tuples in long-term memory and use the stored tuples for retraining an AI agent and/or are otherwise unable to analyze data with the accuracy and efficiency resulting from retraining the AI agent with a stored tuple controlling the decision-making process of the agent.

The present techniques also include dynamically loading or switching tools and/or models based on updates to available memory resources, thus adapting to changes in memory resources in real-time. These elements of the present techniques therefore improve the functioning of a computer or computing device by enabling a computing device to more accurately and efficiently analyze/utilize data as a direct result of the AI agent dynamically loading/switching tools and/or models based on updates to available memory resources during task execution. Conventional techniques do not consider changes in memory resources, leading to potential system failures and/or slowed execution of tasks mid-execution. These elements therefore improve over the prior art at least because existing systems do not load/switch tools and/or models to adapt to changes in memory resources in real-time.

The present disclosure includes specific features other than what is well-understood, routine, conventional activity in the field, and/or otherwise adds unconventional steps that confine the disclosure to a particular useful application, e.g., receive a prompt input including a scientific query; generate, by processing the prompt input using an artificial intelligence (AI) agent including a trained machine learning (ML) model, a set of tasks for answering the scientific query; determine, by the AI agent, one or more tools to execute the set of tasks based on available memory resources; execute the set of tasks using the one or more tools to generate output data corresponding to the scientific query; determine, by the AI agent based on the output data, an observation associated with the scientific query or a ranked listing of the output data; and/or cause at least one of (i) the output data, (ii) the observation, or (iii) the ranked listing to be displayed on an output computing device, among others. The technical improvements and advantages described herein are not the sole improvements and advantages, and other improvements and advantages may be apparent to one of ordinary skill in the art.

### Computing Environment

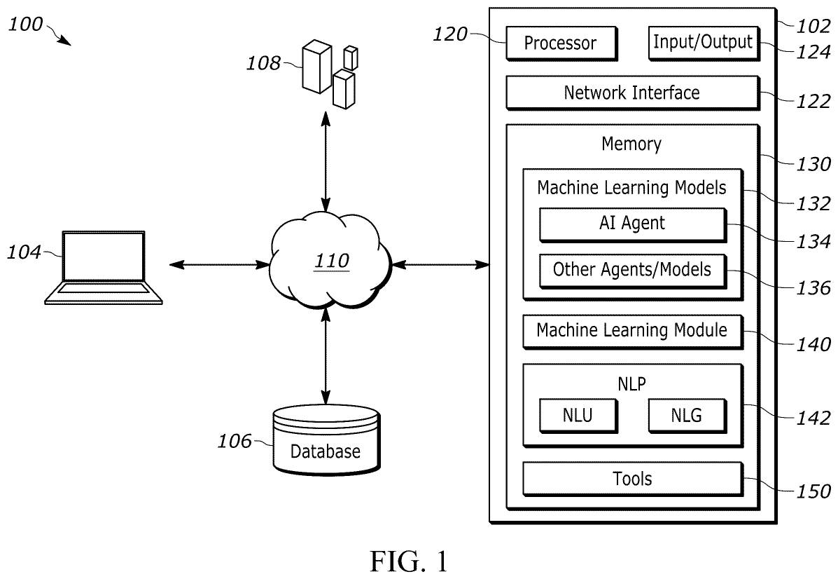

FIG. 1 depicts an example computing environment 100 for scientific computing according to an embodiment. The computing environment may include a server 102, a user device 104, one or more databases 106, exascale computing environment 108, all of which are communicatively connected by the network 110. Although FIG. 1 depicts certain entities, components, equipment, and devices, it should be appreciated that additional or alternate entities, components, equipment, and devices are also possible.

As illustrated in FIG. 1, the computing environment 100 includes, in one embodiment, at least one server 102. The server 102 includes a processor 120, a network interface 122, and input/output (I/O) module 124, and a memory 130. In certain embodiments, the server 102 may be a centralized computing resource configured to execute exascale-level computing tasks, as received from a user (e.g., via user device 104). To execute such tasks, the server 102 utilizes various ML models 132, a ML module 140, natural language processing (NLP) 142 models, and/or one or more tools 150 stored in memory 130.

The server 102 may receive a prompt input including a scientific query from the user device 104 (e.g., via the network 110). The server 102 may process the prompt input and generate a set of tasks to answer the scientific query via the AI agent 134. The set of tasks generated by AI agent 134 may include executable code. The AI agent 134 may determine one or more tools to execute the set of tasks based on available memory resources. In some embodiments, the AI agent may deploy a second agent associated with a second machine learning model to execute one or more tasks from the set of tasks to answer the scientific query. The AI agent 134 may execute the set of code within the exascale computing environment 108 to generate output data, an observation associated with the scientific query, and/or a ranked listing of the output data. In some embodiments, the AI agent 134 may determine that additional processing of the output data is required. In some embodiments, the AI agent 134 may generate a graphical representation of the output data, which may include a plot of the output data. In some embodiments, the AI agent may rank the observations associated with the scientific query.

For example, a server 102 may receive a prompt input including a scientific query from the user device 104 via network 110. The scientific query may relate to determining ignition delay time for methane fuel at different pressures, for example. The AI agent 134 may convert the prompt input into a vector representation of the prompt. The AI agent 134 may generate a set of tasks for determining the ignition delay time for methane fuels at different pressures. The AI agent 134 may receive information about the available memory resources in the system by checking how much video random access memory (VRAM) and/or random-access memory (RAM) is available.

At this point, the AI agent 134 may load and utilize a tool from the tools 150 based on the available memory resources. For example, if 5 GB of RAM is available, the AI agent 134 may choose to utilize a tool to perform the calculations for responding to the prompt input that requires only 4 GB of RAM so as to avoid system failure. The AI agent 134 may deploy a second AI agent including a second trained machine learning model, which may be an LLM, to generate executable code for calculating the ignition delay time of methane fuel. The server 102 may cause the code to be executed in the exascale environment 108. The code may return output data including the different ignition delay times of methane fuel at different pressures. The AI agent 134 may further process the data and/or deploy another AI agent from the other agents/models 136 to further process the data.

For example, the AI agent 134 may deploy a third AI agent including a third machine learning model that is trained to generate observations, i.e., determine points of interest, from the output data. For example, the third AI agent may determine a minimum value, maximum value, average value, etc. for the ignition delay times of methane fuel. The third AI agent may also be able to rank the output data and/or rank the observations of the output data from most to least relevant to the prompt input. In certain embodiments, the third trained machine learning model may be a multimodal machine learning model, and may be used to plot the ignition delay times of methane fuel vs. pressure. One or more of the output ignition delay time data, observations of the ignition delay time data, ranked list of ignition delay time data, ranked observations of the ignition delay time data, or plot of the ignition delay time data may be transmitted to the user device 104 via the I/O module 124 and/or network 110 for display on the user device 104.

The memory 130 may store one or more machine learning models 132, discussed briefly here and in more detail below. The machine learning models 132 may be referred to at times herein as “models,” “machine learning models,” “agents,” and/or “algorithms.”

At least one of the machine learning models 132 may be generative models. Generally speaking, a generative model may be trained to receive input data and generate as an output new content that is reflective of the input. In some embodiments, the generative models include a large language model (LLM). In some embodiments, the generative models include a multimodal machine learning model. In some embodiments, an artificial intelligence (AI) agent 134 (e.g., a machine learning model) may be trained to answer a scientific query, and/or interact with other machine learning models 136 and/or tools 150 to answer a scientific query. The AI agent 134 may generate a set of tasks for answering the scientific query. In some embodiments, the set of tasks generated by the AI agent 134 may include executable code. In some embodiments, the AI agent may perform all of the tasks in the set of tasks for answering the scientific query. In some embodiments, the models 132 may include a plurality of other agents/models 136 to perform specific tasks in the set of tasks for answering the scientific query. For example, other agents/models 136 may generate executable code, generate a graphical representation of the data, generate a plot of the data, and/or rank observations of the data.

The memory 130 may also store a plurality of tools 150, implemented as respective sets of computer-executable instructions as described herein. The tools 150 may include, for example, programming libraries and/or other software to be used in executing a set of tasks for answering a scientific query. For example, the programming libraries may include simulation software, including simulation software problems in specific scientific fields (e.g., the Cantera library for Python for chemical kinetics and thermodynamics problems, Aspen HYSYS), computer-aided design (CAD) tools (e.g., Autodesk, PSpice) and other mathematical modeling and simulation tools (e.g., MATLAB, Simulink, NumPy library for Python).

The server 102 may include only one server, or multiple servers that are co-located and/or remotely distributed. The server 102 may be part of a cloud network or may otherwise communicate with other hardware or software components within one or more cloud computing environments to send, retrieve, or otherwise analyze data or information described herein. In some example embodiments, the computing environment 100 comprises an on-premise computing environment, a multi-cloud computing environment, a public cloud computing environment, a private cloud computing environment, and/or a hybrid cloud computing environment.

The example computing environment 100 includes a network 110 comprising any suitable network or combination of networks, such as a local area network (LAN), a wide area network (WAN), the Internet, or a combination thereof. For example, the network 110 may include a wireless cellular network (e.g., 4G, 5G, 6G, etc.). Generally, the network 110 enables bidirectional communication between the server 102, the user device 104, the databases 106, and/or the exascale computing environment 108. In one embodiment, the network 110 comprises a cellular base station, such as cell tower(s), communicating to the one or more other components of the computing environment 100 via wired/wireless communications based upon any one or more of various mobile phone standards, including NMT, GSM, CDMA, UMTS, LTE, 5G, 6G, or the like. Additionally, or alternatively, the network 110 may comprise one or more routers, wireless switches, and/or other such wireless nodes communicating with the components of the computing environment 100 via wired and/or wireless communications based upon any one or more of various communications standards, including by non-limiting example, IEEE 802.11a/ac/ax/b/c/g/n (Wi-Fi), Bluetooth, and/or the like.

The example server 102 includes processor 120. The processor 120 includes one or more processors, such as central processing units (CPUs), graphics processing units (GPUs), and/or any other suitable processor. The processor 120 is communicatively coupled to a memory 130 via a computer bus (not depicted) to create, read, update, transmit, delete, or otherwise access or interact with the data, data packets, or otherwise electronic signals to and from the processor 120 and the memory 130, e.g., in order to implement or perform the machine-readable instructions, methods, processes, elements, or limitations, as illustrated, depicted, or described for the various flowcharts, illustrations, diagrams, figures, and/or other disclosure herein. The processor 120 interfaces with the memory 130 via a computer bus to execute an operating system and/or computing instructions stored in the memory 130, and/or to access other services/components/etc. For example, the processor 120 may interface with the memory 130 via the computer bus to create, read, update, delete, or otherwise access or interact with the data stored in the memory 124 and/or databases 106.

The server 102 may include a network interface 122 which allows the server 102 to communicate over the network 110 (e.g., with user device 104, a databases 130, the exascale computing environment 108) via any suitable wired and/or wireless connection, e.g., using any suitable network interface controller(s) of the network interface 122. The network interface 122 may include one or more transceivers (e.g., wireless WAN (WWAN), wireless LAN (WLAN), and/or wireless personal area network (WPAN) transceivers) functioning in accordance with IEEE reference standards, 3GPP reference standards, and/or other reference standards that may be used in receipt and transmission of data via external/network ports of the server 102 connected to computer network 110.

In one aspect, the server 102 include an I/O module 124, comprising a set of computer-executable instructions implementing communication functions. The I/O module 124 may further include or implement an operator interface configured to present information to an administrator or operator and/or receive inputs from the administrator and/or operator. An operator interface may provide a display screen. The I/O module 124 may facilitate I/O components (e.g., ports, capacitive or resistive touch sensitive input panels, keys, buttons, lights, LEDs), which may be directly accessible via, or attached to, server 102 or may be indirectly accessible via or attached to the user device 104.

The server 102 may include a memory 130. The memory 130 may include one or more memories and/or forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, etc. The memory 130 stores machine-readable instructions executable by the processor 120, including the instructions of one or more machine learning models 132 and one or more tools 140. The memory 130 also stores an operating system (e.g., Microsoft Windows, Linux, UNIX, etc.) capable of facilitating the functionalities, applications, methods, or other software of the machine learning models 132 and/or tools 150 as discussed herein.

The server 102 may include, and/or have access to (e.g., via network 110), one or more databases 106. The databases 106 may include one or more databases that are co-located or remotely distributed. The databases 106 may be or include a relational database, such as Oracle, DB2, MySQL, a NoSQL based database, such as MongoDB, or another suitable database. The databases 106 may store data and/or datasets discussed herein, such as models, training data used to train and/or operate one or more models, and so on. A dataset may include one or more types of data, records, files, etc. The terms “data” and “dataset” may be used interchangeably herein.

The memory 140 may also store a machine learning module 140 comprising a set of computer-executable instructions implementing machine loading, configuration, initialization, and/or operation functionality. In some embodiments, at least one of a plurality of machine learning methods and algorithms is applied by the machine learning module 140, where the machine learning methods and algorithms may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented machine learning methods and algorithms are directed toward at least one of a plurality of categorizations of machine learning, such as supervised learning, unsupervised learning, and reinforcement learning.

In one aspect, the machine learning based algorithms may be included as a library or package executed on server(s) 102. For example, libraries may include the TensorFlow based library, the HuggingFace library, the PyTorch library, and/or the scikit-learn Python library.

In one embodiment, at least one of the machine learning module 140 may employ supervised learning, which involves identifying patterns in existing data to make predictions about subsequently received data. Specifically, a machine learning model is “trained” (e.g., via the machine learning module 140) using training data, which includes example inputs and associated example outputs. Based upon the training data, a machine learning model may generate a predictive function which maps outputs to inputs and may utilize the predictive function to generate machine learning outputs based upon data inputs. The exemplary inputs and exemplary outputs of the training data may include any of the data inputs or machine learning outputs described above. In the exemplary embodiments, a processing element may be trained by providing it with a large sample of data with known characteristics or features.

In another embodiment, at least one of the machine learning module 140 may employ unsupervised learning, which involves finding meaningful relationships in unorganized data. Unlike supervised learning, unsupervised learning does not involve user-initiated training based upon example inputs with associated outputs. Rather, in unsupervised learning, a machine learning model may organize unlabeled data according to a relationship determined by at least one machine learning method or algorithm. Unorganized data may include any combination of data inputs and/or machine learning outputs as described above.

In yet another embodiment, at least one of the machine learning module 140 may employ reinforcement learning, which involves optimizing outputs based upon feedback from a reward signal. Specifically, a machine learning model may receive a user-defined reward signal definition, receive a data input, utilize a decision-making model to generate the machine learning output based upon the data input, receive a reward signal based upon the reward signal definition and the ML output, and alter the decision-making model so as to receive a stronger reward signal for subsequently generated machine learning outputs. Other types of machine learning may also be employed, including deep or combined learning techniques.

The machine learning module 140 may receive labeled data at an input layer of a model having a networked layer architecture (e.g., an artificial neural network, a convolutional neural network, etc.) for training the one or more machine learning models 132. The received data may be propagated through one or more connected deep layers of the machine learning model to establish weights of one or more nodes, or neurons, of the respective layers. Initially, the weights may be initialized to random values, and one or more suitable activation functions may be chosen for the training process. The present techniques may include training a respective output layer of the one or more machine learning models 132. The output layer may be trained to output a prediction, for example.

In operation, the machine learning module 140 may access the database 106, or any other data source, for training data suitable to generate one or more machine learning models. The training data may be sample data with assigned relevant and comprehensive labels (classes or tags) used to fit the parameters (weights) of a machine learning model with the goal of training it by example. In one aspect, once an appropriate machine learning model is trained and validated to provide accurate predictions and/or responses, the trained model may be loaded into machine learning module 140 at runtime to process input data and generate output data. As discussed, once trained, the one or more trained machine learning models may be operated in inference mode, whereupon when provided with de novo input that the model has not previously been provided, the model may output one or more predictions, classifications, etc., as described herein. The machine learning module 140 may include instructions for storing the trained machine learning models 132 (e.g., in the memory 130, in electronic database 106, etc.).

In various embodiments, examples, and/or aspects disclosed herein may include training and generating one or more ML models for the server 102 to load at runtime. Additionally, or alternatively, one or more appropriately trained machine learning models may already exist (e.g., in the database 106) such that the server 102 may load an existing trained ML model at runtime. In some implementations, server 102 may retrain, fine-tune, update and/or otherwise alter an existing ML model before and/or after loading the model at runtime.

The memory 130 may include one or more NLP modules 142 comprising a set of computer-executable instructions implementing NLP, natural language understanding (NLU) and/or natural language generator (NLG) functionality. The NLP module 142 may be responsible for transforming the user input (e.g., unstructured conversational input such as speech or text) to an interpretable format. The NLP module 142 may include NLU processing to understand the intended meaning of utterances, among other things. The NLP module 142 may include NLG which may provide text summarization, machine translation, and/or dialog where structured data is transformed into natural conversational language (i.e., unstructured) for output to the user. As an example, the NLP modules 142 and/or the ML models 132 described herein may train and/or be trained to perform at least two techniques that may enable the models to understand words spoken/written by a user: syntactic analysis and semantic analysis.

Syntactic analysis generally involves analyzing text using basic grammar rules to identify overall sentence structure, how specific words within sentences are organized, and how the words within sentences are related to one another. Syntactic analysis may include one or more sub-tasks, such as tokenization, part of speech (POS) tagging, parsing, lemmatization and stemming, stop-word removal, and/or any other suitable sub-task or combinations thereof. For example, using syntactic analysis, the NLP modules 142 and/or the ML models 132 described herein may generate textual transcriptions from verbal responses from a user in a data stream.

Semantic analysis generally involves analyzing text in order to understand and/or otherwise capture the meaning of the text. In particular, the NLP modules 142 and/or the ML models 132 described herein applying semantic analysis may study the meaning of each individual word contained in a textual transcription in a process known as lexical semantics. Using these individual meanings, the NLP modules 142 and/or the ML models 132 described herein may then examine various combinations of words included in the sentences of the textual transcription to determine one or more contextual meanings of the words. Semantic analysis may include one or more sub-tasks, such as word sense disambiguation, relationship extraction, sentiment analysis, and/or any other suitable sub-tasks or combinations thereof. For example, using semantic analysis, the NLP modules 142 and/or the ML models 132 described herein may generate one or more intent interpretations based upon one or more textual transcriptions from a syntactic analysis.

The server 102 may also be in communication with a user device 104. The user device 104 may comprise one or more computers and/or multiple, redundant, or replicated client computers accessible to one or more users. The user device 104 may include one or more computing devices (e.g., desktop computer, laptop computer, terminal), mobile devices, wearables, smart watches, smart contact lenses, smart glasses, augmented reality glasses/headsets, virtual reality glasses/headsets, mixed or extended reality glasses/headsets, and/or other suitable electronic or electrical components. The user device 104 may include a processor and a memory for, respectively, storing and executing one or more modules, computer-executable instructions, etc. The memory may include one or more suitable storage media such as a magnetic storage device, a solid-state drive, random access memory (RAM), etc. The user device 104 may include a network interface to access services or other components of the computing environment 100 via the network 110. For example, the user of user device 104 may provide a prompt input including a scientific query to the server 102 over the network 110, and/or output data responsive to the prompt from the server 102.

The computing environment 100 may include an exascale computing environment 108 to execute code from the set of tasks to answer the scientific query. The exascale computing environment 108 may include several components working together to perform large-scale computations, such as a plurality of nodes each including processors, such as CPUs, GPUs, high-performance processors (e.g., AMD EPYC, Intel Xeon, or NVIDIA GPUs); large amounts of memory (e.g., random-access memory); high-speed storage solutions (e.g., nonvolatile memory express, solid-state drives, SSDs, distributed storage systems, and parallel file systems), high-speed interconnects (e.g., InfiniBand, Omni-Path, high-speed Ethernet) for fast data transfer between nodes, and a network interface, among other components.

The computing environment 100 may include additional, fewer, and/or alternate components, and may be configured to perform additional, fewer, or alternate actions, including components/actions described herein. For instance, information described as being stored at database 106 may be stored at memory 130, and therefore database 106 may be omitted. Moreover, it should be appreciated that additional and/or alternative connections between components shown in FIG. 1 may be implemented. As just one example, server 102 and database 106 may be connected via a direct communication link (not shown in FIG. 1) instead of, or in addition to, via the network 110.

### Example Machine Learning Model Training

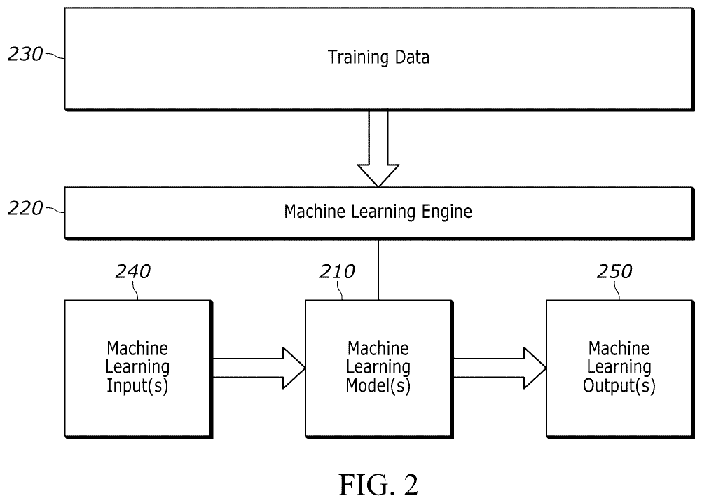

FIG. 2 illustrates a flow diagram for example training and operation of a machine learning model 210 (e.g., the machine learning models 134, 136), according to some embodiments. The example training and/or operation of the machine learning model 210 may be performed by the computing environment 100.

A machine learning engine 220 (e.g., the machine learning module 140 of the server 102) may include one or more hardware and/or software components to obtain, create, (re) train, fine-tune, and/or store one or more machine learning models, such as the machine learning model 210. To train the machine learning model 210, the machine learning engine 220 may use training data 230. A server, such as server 102, may obtain and/or have available one or more types of training data 230 (e.g., training data stored in the database 130). In one aspect, at least some of the training data 230 may be labeled to aid in (re) training and/or fine-tuning the machine learning model 210. In some embodiments, the training data 230 may include tuples for controlling a decision-making process. During training of the machine learning model 210 by the machine learning engine 220, the machine learning model 210 may be configured to process the training data 230 to learn associations and relationships in the training data 230.

In some embodiments, the machine learning engine 220 updates the training data 230 as needed, e.g., to include new data. Such data may be stored as updated training data 230. For example, the machine learning engine 220 may update the training data 230 with a new tuple created as a result of a new prompt input and generated output. Subsequently, the machine learning model 210 may be retrained based upon the updated training data 230, or the new portions thereof, which may cause the machine learning model 210 to improve (e.g., make more accurate predictions) over time. For example, the machine learning model 210 may improve generating a set of tasks for answering a scientific query, or improve on ranking output data in scientific contexts.

In some embodiments, the machine learning engine 220 trains the machine learning model 210 using the training data 230 to generate the output 250 based on receiving the input 240. Once trained, the machine learning model 210 may perform operations on one or more data inputs 240 to produce a desired data output 250, as discussed above. In one aspect, the machine learning model 210 is loaded at runtime from a database (e.g., the model 210 loaded by the machine learning engine 220 from the database 106). The server and/or machine learning engine 220 may obtain the input data 240 (e.g., from the database 106), and the machine learning engine 220 may provide the input data 240 to the trained machine learning model 210 as an input, for the machine learning model 210 to generate the output 250.

In at least some aspects, the same server and/or other suitable component/device, both trains the machine learning model 210, and executes the trained machine learning model 210. In at least some aspects, a first server and/or other suitable component/device trains the machine learning model 210, and a second server and/or other suitable component/device executes the trained machine learning model 210.

### Example System for Scientific Computing

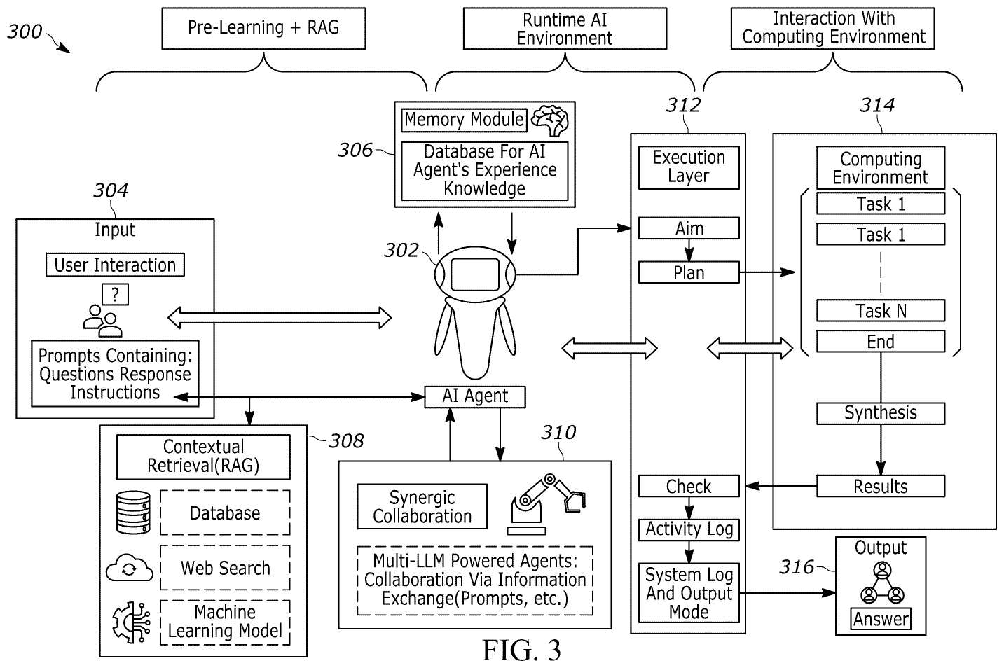

FIG. 3 depicts a combined block and flow diagram of an example system 300 for scientific computing.

The system may include an AI agent 302. The AI agent 302 may process a prompt input 304 that includes a scientific query to generate a set of tasks for answering the scientific query. The AI agent 302 may be, include, and/or otherwise reference a trained machine learning model, such as a large language model (LLM).

A memory module 306 may include a database for the AI agent 302, which stores data for controlling the AI agent's 302 decision-making process. In some embodiments, such data may be a tuple (i.e., a finite sequence or ordered list of elements in the form of a vector or other suitable mathematical representation), and the tuple may model the relationship between the AI agent 302 and its environment. The tuple may be used in a partially observable Markov decision process (POMDP) algorithm. For example, the tuple may include a set of states S, a set of actions A, a set of conditional transition probabilities between states T, a reward function R, a set of observations Ω, a set of conditional observations probabilities O, and a discount factor γ. In some embodiments, the tuple may be stored in long-term memory, such as in a database. The stored tuple may be used to retrain the AI agent 302. The tuple may associate a prompt input and/or scientific query with a set of tasks. A current tuple (i.e., currently being used to control the decision-making process of the AI agent 302) may be loaded into working memory, and may be used by the AI agent 302 to generate a set of tasks for answering the scientific query. The AI agent 302 may also search the long-term memory for a tuple that is relevant to the prompt input and/or scientific query associated with the prompt input. The AI agent 302 may calculate a similarity score between the current tuple and one or more tuples stored in long-term memory. The similarity score may be a measure of similarity between the current tuple and the tuples stored in long-term memory. In some embodiments, the similarity score may be a distance value between the current tuple and a tuple stored in the long-term memory. In some embodiments, calculating a similarity score may include checking whether the current tuple and a tuple stored in long-term memory include the same elements in the same order. When a stored tuple that is relevant to the current tuple is found (i.e., the similarity score is above a threshold), a set of tasks associated with the current tuple may be updated based on the set of tasks associated with the stored tuple.

The AI agent 302 may receive prompt input 304. The prompt input may include instructions, a scientific query, and/or other questions. A retrieval augmented generation (RAG) process 308 may be applied to the prompt to provide contextual information to the prompt. The contextual information may be retrieved from a database, such as database 106 of FIG. 1, from an Internet search, and/or other machine learning models. For example, documents about different types of fuels may be stored in a database 106. The information may be converted into a vector, which may be stored in a vector database. A prompt input 304 requesting ignition delay time for methane fuel may be converted into a vector representation of the prompt input and matched with a vector stored in the vector database associated with information about different types of fuels. The documents about different types of fuels may be returned and added to the prompt input 304 so that the AI agent 302 may generate a set of tasks and/or output data that more accurately answers the scientific query regarding the ignition delay time for methane fuel.

The AI agent 302 may determine which tools and/or machine learning models 310 are needed to execute the set of tasks for answering the scientific query. The AI agent 302 may determine what memory resources are available for executing the set of tasks. For example, the AI agent 302 may check the state of random-access memory (RAM) and/or video random access memory (VRAM) of the system. The AI agent 302 may load specific tools and/or machine learning models 310 based on the available memory resources. For example, the AI agent 302 may select tools and/or machine learning models that do not use more memory resources than are available and will not cause the system to fail. For example, there may be 5 GB of VRAM available, so a particular machine learning model requiring less than 4.5 GB of VRAM may be selected. The particular machine learning model will not use more memory resources than is available, and uses 0.5 GB VRAM less than the maximum amount of available VRAM to ensure the system does not fail and/or crash. In some embodiments, the AI agent 302 may load a quantized version of a machine learning model (i.e., a version of the machine learning model that uses less memory resources).

At block 312, the AI agent may generate and execute the set of tasks to answer the scientific query. In some embodiments, the set of tasks may include executable code (e.g., job scripts). The code may be used to run one or more simulations to answer the scientific query. In some embodiments, the AI agent 302 may receive updated information about available memory resources. For example, parts of the system may experience a failure, or task may be executing unexpectedly slowly due to changes in available memory resources. For example, although 5 GB of VRAM may have been available when AI agent first generated a set of tasks and determined which tools to use to execute the set of tasks, a node in the exascale computing environment may suddenly fail (e.g., due to physical component failure, software bugs, etc.), reducing the available amount of VRAM in the system such that only 4 GB of VRAM is available. The AI agent 302 may dynamically switch or load the tools and/or machine learning models used to execute the set of tasks based on the updated available memory resources information. The code may be executed in a computing environment 314. In some implementations, the computing environment may be an exascale computing environment.

The system may generate output data 316. In some embodiments, the output data 316 may be a set of files containing structured data arrays. In some embodiments, additional processing of the output data 316 may be performed. The AI agent 302 may deploy a second AI agent associated with a second trained machine learning model, which may be a multimodal machine learning model. In some embodiments, a graphical representation of the output data 316, such as a plot and/or time sequence animation, may be created. The second AI agent may make observations from the output data and/or rank the output data. In some embodiments, the observations may be ranked from most to least relevant to the prompt input.

### Example Workflow for an Example Prompt Input

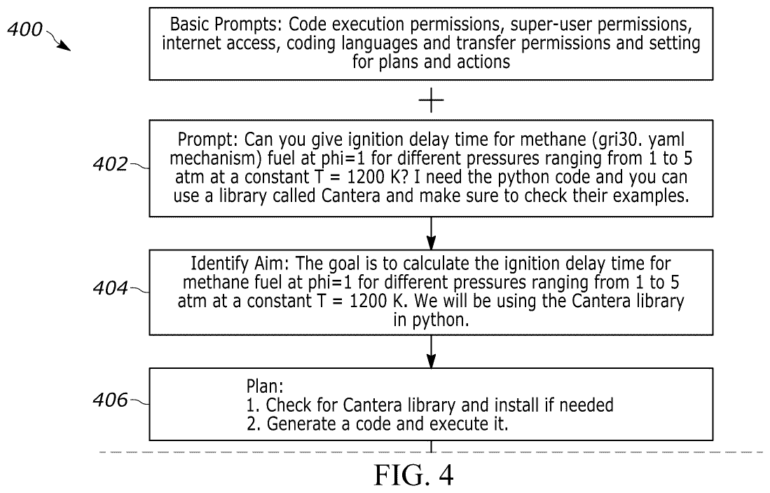

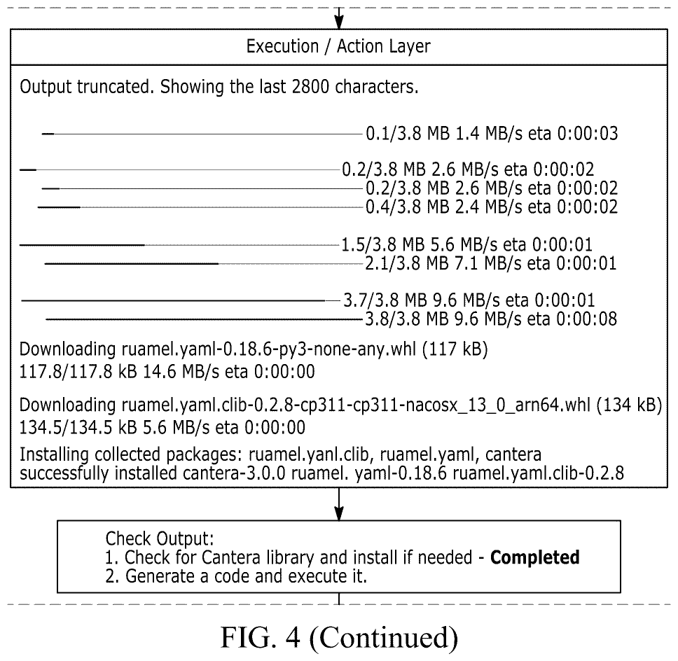

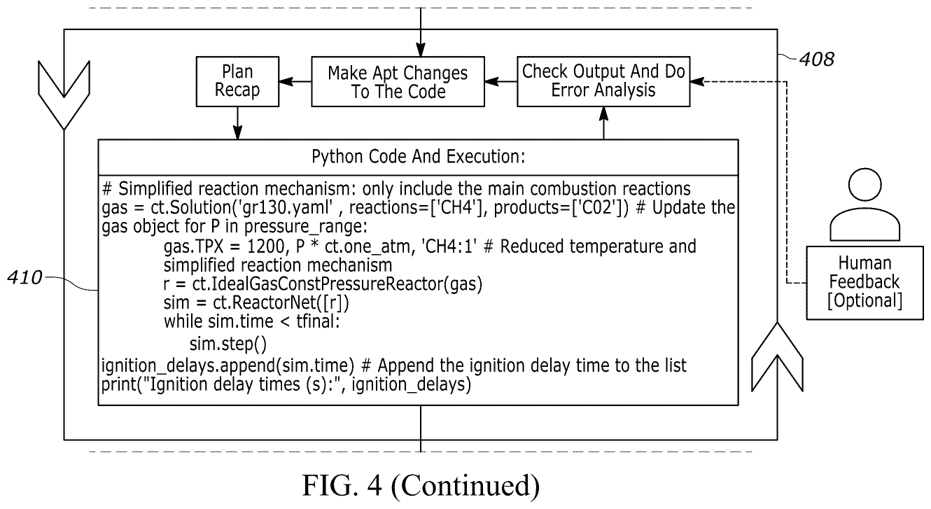

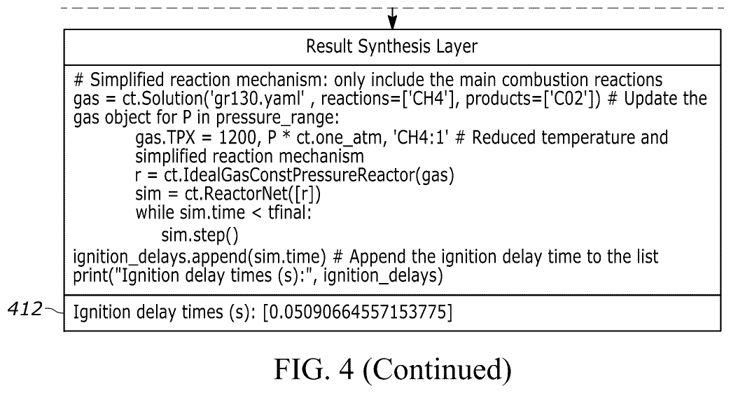

FIG. 4 depicts a combined block and flow diagram of an example workflow 400 for scientific computing. In this example, the user of a user device (e.g., user device 104 of FIG. 1, provides a prompt input 402 to a server (e.g., server 102 of FIG. 1). The prompt input 402 may include a scientific query (“Can you give me ignition delay time for methane (gri30.yaml mechanism) fuel at phi=1 for different pressures ranging from 1 to 5 atm at a constant T=1200 K?”) and instructions (“I need python code and you can use a library called Cantera and make sure to check their examples.”).

An AI agent stored on the server (e.g., AI agent 134) may process the prompt at block 404. At block 406, the AI agent may generate a set of tasks to answer the scientific query (i.e., determining the ignition delay time for methane fuel at phi=1 for different pressures ranging from 1 to 5 atm at a constant T=1200 K), which may include checking for the Cantera library and installing it, and generating executable code for answering the scientific query. At block 408, the AI agent may generate the executable code 410, check the output of the code, analyze the code for errors, and make changes to the code. In some embodiments, the AI agent may deploy other AI agents and machine learning models or algorithms to execute one or more tasks in the set of tasks. For example, the AI agent may call a trained LLM to generate the code for calculating the ignition delay time for methane fuel at phi=1 for different pressures using the specified Cantera library. The user of the user device may also provide feedback. Executing the code 410 may generate an output 412 (“Ignition delay times(s): [0.05000664557153775]”) which answers the scientific query in the prompt input (ignition delay time for methane fuel at phi=1 for different pressures ranging from 1 to 5 atm at a constant T=1200 K).

### Example Method for Scientific Computing

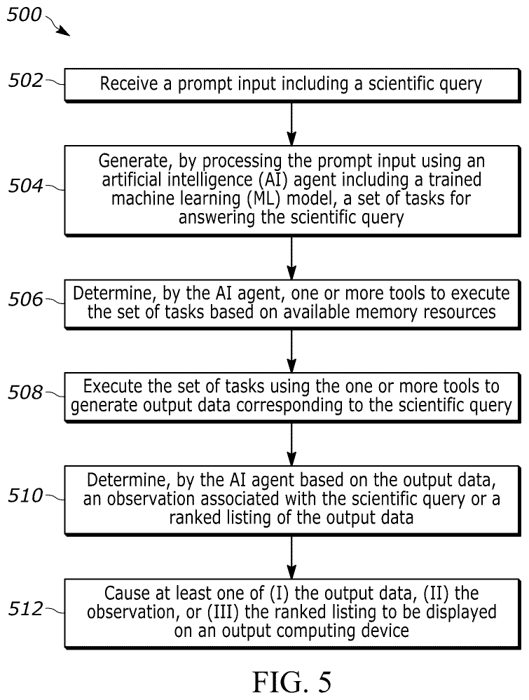

FIG. 5 depicts a flow diagram of an example method 500 for scientific computing, specifically for ignition delay calculations. One or more blocks of the method 500 may be implemented as a set of instructions stored on a computer-readable memory and executable on one or more processors. The method 500 may be implemented via one or more local or remote processors such as the processor 120, servers such as the server 102, systems such as the computing environment 100, and/or other electronic or electrical components, which may be communicatively coupled with one another. In some embodiments, the tasks may be executed in an exascale computing environment.

The method 500 may include receiving a prompt input including a scientific query at block 502. In some implementations, context information corresponding to the prompt input may be retrieved from a database and may be injected to the prompt input and/or the AI agent object (i.e., retrieval augmented generation).

At block 504, the method 500 may include generating, by processing the prompt input using an artificial intelligence (AI) agent including a trained machine learning (ML) model, a set of tasks for answering the scientific query. In some embodiments, the trained machine learning model may be a large language model (LLM). In some embodiments, the set of tasks may include generating executable code. In some embodiments, a tuple may control a decision-making process of the AI agent. The tuple may be used in a partially observable Markov decision process (POMDP) algorithm. In some embodiments, the tuple may be stored in a database (i.e., long-term memory). In some embodiments, the tuple may be used to retrain the AI agent. In some embodiments, a current tuple (i.e., currently being used to control the decision-making process of the AI agent) may be loaded into working memory. A similarity score between the current tuple and one or more tuples stored in a database may be calculated. The similarity score may be a measure of similarity between the current tuple and a tuple stored in the database are (e.g., a distance).

At block 506, the method 500 may include determining, by the AI agent, one or more tools to execute the set of tasks based on available memory resources. In some embodiments, determining a tool to execute the set of tasks may include determining an amount of memory required by a tool is less than a threshold amount of memory causing a memory failure. In some embodiments, the AI agent may determine the tools to execute the set of tasks based on available processing resources. In some embodiments, the system may receive updated available memory resources and execute the set of tasks based on the updated available memory resources. In some embodiments, the system may dynamically switch a current machine learning model used to execute the set of tasks to another machine learning model based on the updated available memory resources. In some embodiments, the other machine learning model may be a quantized version of the current trained machine learning model. The quantized version of the trained machine learning model may use less resources than the non-quantized version. The quantized trained machine learning model may operate with less precision than the non-quantized trained machine learning model.

At block 508, the method 500 may include executing the set of tasks using the one or more tools to generate output data according to the scientific query.

At block 510, the method 500 may include determining, by the AI agent and based on the output data, an observation associated with the scientific query or a ranked listing of the output data. In some embodiments, the AI agent may determine characteristics of the output data, determine the relevance of each characteristic of the output data to the prompt input, and rank the characteristics of the output data from most relevant to least relevant to the prompt input.

At a block 512, the method 500 may include causing at least one of the (i) output data, (ii) the observation, or (iii) the ranked listing to be displayed on an output computing device.

In some embodiments, the AI agent may deploy a second agent to execute one or more tasks in the set of tasks, based on the available computing resources. The second agent may include a second trained machine learning model. In some embodiments, the second trained machine learning model may be a multimodal machine learning model. In some embodiments, the system may determine that additional processing of the output data is required. In some embodiments, the output data, the observation, or the ranked listing may be a multimodal output. In some embodiments, the second trained machine learning model may be trained to generate a graphical representation of the output data, such as a plot or graph of the output data.

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A system for scientific computing, the system comprising:
one or more processors; and
one or more memories having stored thereon computer-executable instructions that, when executed by the one or more processors, cause the system to:
receive a prompt input including a scientific query;
generate, by processing the prompt input using an artificial intelligence (AI) agent including a trained machine learning (ML) model, a set of tasks for answering the scientific query;
determine, by the AI agent, one or more tools to execute the set of tasks based on available memory resources;
execute the set of tasks using the one or more tools to generate output data corresponding to the scientific query;
determine, by the AI agent based on the output data, an observation associated with the scientific query or a ranked listing of the output data; and
cause at least one of (i) the output data, (ii) the observation, or (iii) the ranked listing to be displayed on an output computing device.

2. The system of claim 1, wherein the trained machine learning model is a large language model (LLM).

3. The system of claim 1, wherein the computer-executable instructions further cause the system to store, in a database, a tuple for controlling a decision-making process of the agent for generating the set of tasks.

4. The system of claim 3, wherein the computer-executable instructions further cause the system to:
in response to receiving at least one of a new prompt input or a new scientific query, autonomously adapt the decision-making process of the agent by retraining the agent object with the stored tuple.

5. The system of claim 3, wherein the computer-executable instructions further cause the system to:
load a current tuple for controlling a decision-making process of the agent for generating a current set of tasks into working memory;
retrieve the stored tuple from a database, wherein a similarity score between the current tuple and a stored threshold is above a threshold; and
update the current set of tasks with the set of tasks associated with the stored tuple.

6. The system of claim 1, wherein the computer-executable instructions further cause the system to:
receive context information corresponding to the prompt input; and
inject the context information to the prompt input and/or to the AI agent.

7. The system of claim 1, wherein the computer-executable instructions further cause the system to determine, by the AI agent, one or more tools to execute the set of tasks based on available processing resources.

8. The system of claim 1, wherein determining one or more tools to execute the set of tasks based on available memory resources includes determining an amount of memory required by a tool of the one or more tools to execute the set of tasks is less than a threshold amount of memory causing a memory failure.

9. The system of claim 1, wherein the computer-executable instructions further cause the system to:
receive updated available memory resources; and
execute the set of tasks based on the updated available memory resources.

10. The system of claim 7, wherein the computer-executable instructions further cause the system to:
dynamically switch a current machine learning model used to execute the set of tasks to another machine learning model based on the updated available memory resources.

11. The system of claim 10, wherein the another trained machine learning model is a quantized version of the current trained machine learning model, wherein the quantized version of the another trained machine learning model uses less memory resources than the current trained machine learning model.

12. The system of claim 1, wherein the computer-executable instructions further cause the system to:
determine, based on the scientific query and the output data, that additional processing of the output data is required.

13. The system of claim 1, wherein the computer-executable instructions further cause the system to:
select, by the AI agent and based on the available computing resources and prompt input, a second agent including a second trained machine learning model; and
execute, by the second agent, one or more tasks in the set of tasks.

14. The system of claim 12, wherein the second trained machine learning model is a multimodal machine learning model.

15. The system of claim 14, wherein the at least one of (i) the output data, (ii) the observation, or (iii) the ranked listing is a multimodal output.

16. The system of claim 14, wherein the second trained machine learning model is trained to generate a graphical representation of the output data corresponding to the scientific query.

17. The system of claim 16, wherein the graphical representation of the output data is a plot of the output data.

18. The system of claim 1, wherein the computer-executable instructions further cause the system to:
determine a relevance of each observation of the output data to the prompt input; and
rank the observations of the output data from most relevant to least relevant to the prompt input.

19. The system of claim 1, wherein the set of tasks includes generating a set of executable code.

20. The system of claim 1, wherein the set of tasks are executed in an exascale computing environment.

21. A method for scientific computing, the method comprising:
receiving, by one or more processors a prompt input including a scientific query;
generating, by the one or more processors and processing the prompt input using an artificial intelligence (AI) agent including a trained machine learning (ML) model, a set of tasks for answering the scientific query;
determining, by the one or more processors and the AI agent, one or more tools to execute the set of tasks based on available memory resources;
executing, by the one or more processors, the set of tasks using the one or more tools to generate output data corresponding to the scientific query;
determining, by the one or more processors and the AI agent based on the output data, an observation associated with the scientific query or a ranked listing of the output data; and
causing, by the one or more processors, at least one of (i) the output data, (ii) the observation, or (iii) the ranked listing to be displayed on an output computing device.

22. The method of claim 21, wherein the trained machine learning model is a large language model (LLM).

23. The method of claim 21, further comprising storing, in a database, a tuple for controlling a decision-making process of the agent for generating the set of tasks.

24. The method of claim 23, further comprising:
in response to receiving at least one of a new prompt input or a new scientific query, autonomously adapt the decision-making process of the agent by retraining, by the one or more processors, the agent object with the stored tuple.

25. The method of claim 23, further comprising:
loading, by the one or more processors, a current tuple for controlling a decision-making process of the agent for generating a current set of tasks into working memory;
retrieving, by the one or more processors, the stored tuple from a database, wherein a similarity score between the current tuple and a stored threshold is above a threshold; and
updating, by the one or more processors, the current set of tasks with the set of tasks associated with the stored tuple.

26. The method of claim 21, further comprising:
receiving, by the one or more processors, context information corresponding to the prompt input; and
injecting, by the one or more processors, the context information to the prompt input and/or to the AI agent.

27. The method of claim 21, further comprising:
determining, by the one or more processors and the AI agent, one or more tools to execute the set of tasks based on available processing resources.

28. The method of claim 21, wherein determining one or more tools to execute the set of tasks based on available memory resources includes determining an amount of memory required by a tool of the one or more tools to execute the set of tasks is less than a threshold amount of memory causing a memory failure.

29. The method of claim 21, further comprising:
receiving, by the one or more processors, updated available memory resources; and
executing, by the one or more processors, the set of tasks based on the updated available memory resources.

30. The method of claim 27, further comprising:
dynamically switching, by the one or more processors, a current machine learning model used to execute the set of tasks to another machine learning model based on the updated available memory resources.

31. The method of claim 30, wherein the another trained machine learning model is a quantized version of the current trained machine learning model, wherein the quantized version of the another trained machine learning model uses less memory resources than the current trained machine learning model.

32. The method of claim 21, further comprising:
determining, by the one or more processors and based on the scientific query and the output data, that additional processing of the output data is required.

33. The method of claim 21, further comprising:
selecting, by the one or more processors and the AI agent and based on the available computing resources and prompt input, a second agent including a second trained machine learning model; and
executing, by the one or more processors and the second agent, one or more tasks in the set of tasks.

34. The method of claim 32, wherein the second trained machine learning model is a multimodal machine learning model.

35. The method of claim 34, wherein the at least one of (i) the output data, (ii) the observation, or (iii) the ranked listing is a multimodal output.

36. The method of claim 34, wherein the second trained machine learning model is trained to generate a graphical representation of the output data corresponding to the scientific query.

37. The method of claim 36, wherein the graphical representation of the output data is a plot of the output data.

38. The method of claim 1, further comprising:
determining, by the one or more processors, a relevance of each observation of the output data to the prompt input; and
ranking, by the one or more processors, the observations of the output data from most relevant to least relevant to the prompt input.

39. The method of claim 21, wherein the set of tasks includes generating a set of executable code.

40. The method of claim 21, wherein the set of tasks are executed in an exascale computing environment.
